(19) United States
(12) Patent Application Publication
(10) Pub. No.: US 2012/0075215 A1
(43) Pub. Date: Mar. 29, 2012

(54) SINGLE LAYER IMPLEMENTED TWO DIMENSIONAL TOUCHPAD

(75) Inventor: I-HAU YEH, TAIPEI CITY (TW)

(73) Assignee: ELAN MICROELECTRONICS CORPORATION, HSINCHU (TW)

(21) Appl. No.: 13/231,086

(22) Filed: Sep. 13, 2011

(30) Foreign Application Priority Data
Sep. 24, 2010 (TW) 099132314

(51) Int. Cl. G06F 3/041

(52) U.S. Cl. 345/173

(57) ABSTRACT

A single-layer implemented two-dimensional touchpad includes two groups of sensing units arranged abreast along two directions, respectively. The first group of sensing units have one end adjacent to the connection region of the touchpad and are connected with wires routing to the connection region. The second group of sensing units are connected with wires bypassing the first group of sensing units and routing to the connection region. This arrangement decreases the number of wires routing through the margin of the circuit board of the touchpad to downsize the margin width and reduce the limitation to the touchpad size simultaneously, only by changing the layout of the sensing units, without increasing the manufacturing mask and steps.

### FIELD OF THE INVENTION

The present invention is related generally to a touchpad and, more particularly, to a single-layer implemented two-dimensional touchpad.

### BACKGROUND OF THE INVENTION

As shown in FIG. 1, a conventional single-layer implemented two-dimensional capacitive touchpad includes a plurality of sensing units 12, each composed of a pair of face-to-face wedged sensing electrodes 14 and 16 made of ITO and spaced from each other with a gap. It is well known that a capacitor has a capacitance

$$C ∝ \frac{ɛ \times A}{d} , \qquad [ Eq \text{-} 1 ]$$

where A and d are the overlapped area of and the distance between the two electrode plates of the capacitor, respectively, and ε is the dielectric constant of the dielectric layer between the two electrode plates of the capacitor. When a conductor 18 contacts over the sensing unit 12, according to the equation Eq-1, two capacitances C1 and C2 established by the conductor 18 and the sensing electrodes 14 and 16, respectively, will vary with the contact areas of the conductor 18 over the sensing electrodes 14 and 16, respectively. Based on the variations of the capacitances C1 and C2, the location of the conductor 18 in X direction can be determined. For this type of touchpads, however, since each sensing unit 12 has two sensing electrodes to generate two sensed values, respectively, it requires more metal wires routing from the sensing units 12 to the connection region 20 for transmitting the sense values to a sensor 22, and thus requires the circuit board of the touchpad to have a greater margin width Wb for routing the metal wires. As a result, the touchpad will have a larger size and less pleasing appearance. If the sensing units 12 are arranged with the sensing electrodes extending vertically to reduce the margin width Wb, the length of each sensing unit 12 has to be limited for ensuring the touch sensitivity, which in turn causes limitation to the overall size of the resultant touchpad.

### SUMMARY OF THE INVENTION

An objective of the present invention is to provide a single-layer implemented two-dimensional touchpad having a reduced margin width for wire routing.

According to the present invention, a single-layer implemented two-dimensional touchpad includes two groups of sensing units arranged abreast along two directions, respectively. The first group of sensing units have one end adjacent to the connection region of the touchpad and are connected with wires routing to the connection region. The second group of sensing units are connected with wires bypassing the first group of sensing units and routing to the connection region.

This arrangement of sensing units decreases the number of wires routing through the margin of the circuit board of the touchpad to downsize the margin width and reduce the limitation to the touchpad size simultaneously, only by changing the layout of the sensing units, without increasing the manufacturing mask and steps.

### BRIEF DESCRIPTION OF THE DRAWINGS

These and other objectives, features and advantages of the present invention will become apparent to those skilled in the art upon consideration of the following description of the preferred embodiments according to the present invention taken in conjunction with the accompanying drawings, in which:

FIG. 1 is the layout of a conventional single-layer implemented two-dimensional touchpad;

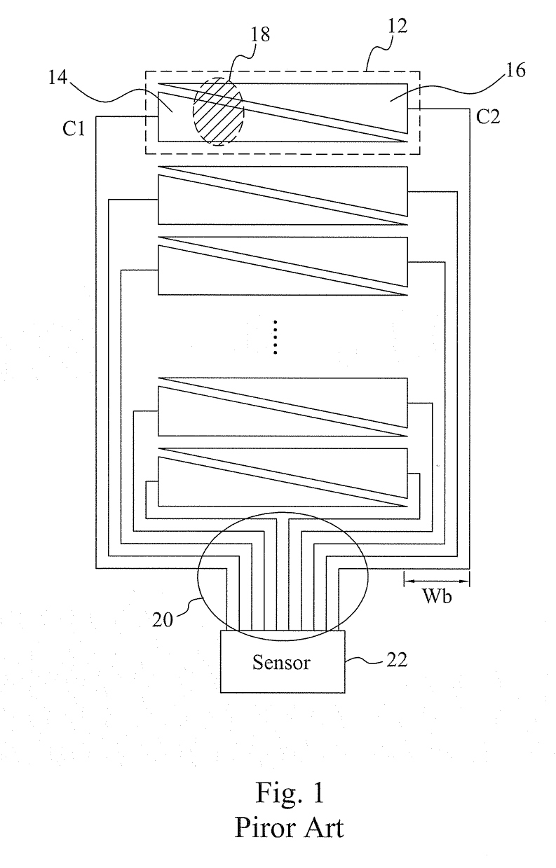

FIG. 2 is the layout of a first embodiment according to the present invention; and

FIG. 3 is a second embodiment of the sensing unit according to the present invention for single-layer implemented two-dimensional touchpads.

### DETAILED DESCRIPTION OF THE INVENTION

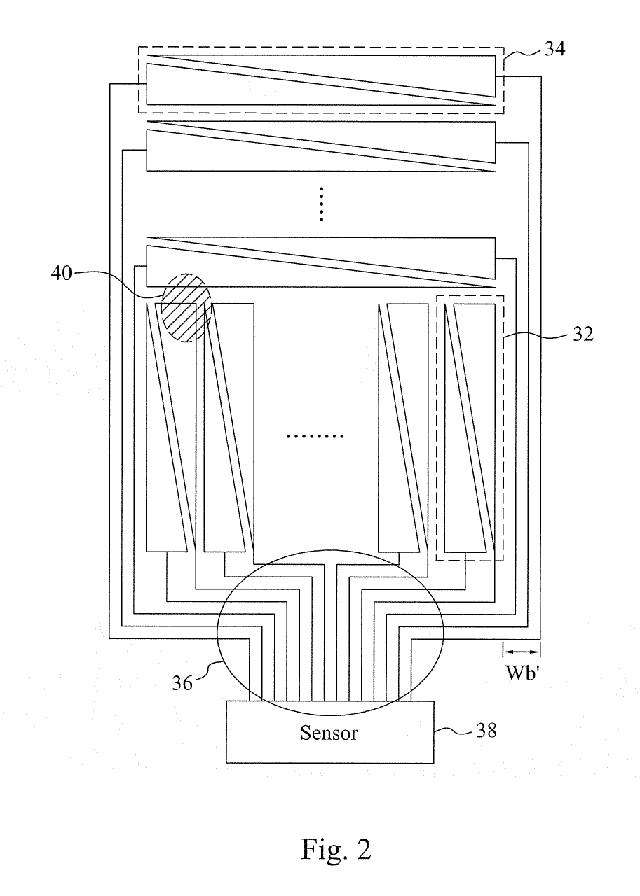

In an embodiment according to the present invention, as shown in FIG. 2, the layout of a single-layer implemented two-dimensional touchpad is so arranged that two groups of sensing units 32 and 34 extend along two directions, respectively. The same as a conventional single-layer implemented two-dimensional touchpad, each of the sensing units 32 and 34 is composed a pair of face-to-face wedged sensing electrodes. However, the group of sensing units 32 are arranged abreast along X direction, whose sensing electrodes extend along Y direction and have one end adjacent to the connection region 36, with wires routing to the connection region 36 from the end adjacent to the connection region 36; and the other group of sensing units 34 are arranged abreast along Y direction and have the sensing electrodes extending along X direction as conventionally, whose wires bypass the sensing units 32 to route to the connection region 36. This arrangement having the sensing units 32 and 34 provided from a same conductor layer can decrease the number of wires routing through the margin of the circuit board to downsize the margin width Wb′ and reduce the limitation to the touchpad size simultaneously, only by changing the layout, without increasing the manufacturing mask and steps. In the course of sensing and positioning a conductor touching the touchpad, when the conductor contacts only over the sensing units 32, the X coordinate can be determined by the position of the touched sensing units 32, and the Y coordinate can be determined from the capacitance variation of the touched sensing units 32. Similarly, when the conductor contacts only over the sensing units 34, the Y coordinate can be determined by the position of the touched sensing units 34, and the X coordinate can be determined from the capacitance variation of the touched sensing units 34. In the event that a conductor 40 is placed between the sensing units 32 and 34 as shown in FIG. 2, the X and Y coordinates can be directly determined from the capacitance variations of the touched sensing units 32 and 34.

The sensing units 32 and 34 may be made of metal or other conductive materials, such as ITO. The wires may also be made of metal or other conductive materials, such as ITO. By using a same material, for example ITO, in the manufacturing process, it can save a mask and the corresponding process and thereby reduce the manufacturing costs.

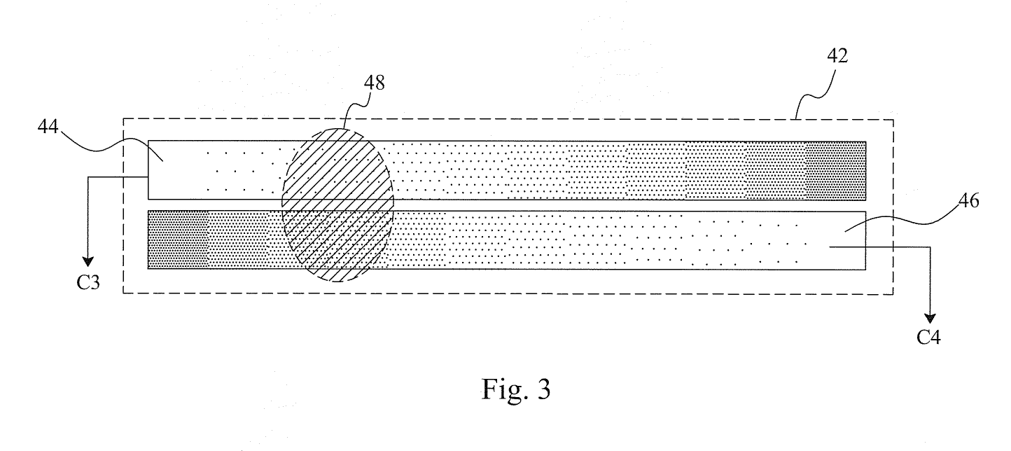

FIG. 3 is a second embodiment of the sensing unit according to the present invention for single-layer implemented two-dimensional touchpads. In this embodiment, a sensing unit 42 is also composed of a pair of parallel strip sensing electrodes 44 and 46. The sensing electrode 44 is formed with holes arranged in a progressively decreased density from right to left while the sensing electrode 46 is formed with holes arranged a progressively increased density from right to left. The holes distributed on the sensing electrodes 44 and 46 across the length in a varying density manner will result in the effective dielectric constant ε of the capacitor established by the sensing electrode 44 or 46 to have a spatial distribution, in the manner that the denser the holes are, the larger the capacitance variation is. When a conductor 48 touches over the sensing unit 42, according to the equation Eq-1, the induced capacitances C3 and C4 will have values depending on the touch position due to the spatial distribution of the dielectric constant ε. From the variation of the capacitances C3 and C4, the location of the conductor 48 in X direction can be determined. The mask may be designed with the holes to be patterned on the sensing electrodes 44 and 46, so as not to increase the process steps for making the sensing unit 42.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A single-layer implemented two-dimensional touchpad comprising:
a connection region;
a first group of sensing units arranged abreast along a first direction, each having one end adjacent to the connection region and connected with wires routing to the connection region; and
a second group of sensing units arranged abreast along a second direction, and connected with wires bypassing the first group of sensing units and routing to the connection region.

2. The touchpad of claim 1, wherein each of the first and second groups of sensing units is composed of a pair of sensing electrodes for defining a position when being touched.

3. The touchpad of claim 2, wherein each pair of the sensing electrodes have a face-to-face wedged shape.

4. The touchpad of claim 2, wherein each of the sensing electrodes is formed with holes arranged in a progressively decreased density.

5. The touchpad of claim 2, wherein each of the sensing electrodes is made of metal.

6. The touchpad of claim 2, wherein each of the sensing electrodes is made of ITO.

7. The touchpad of claim 1, wherein each of the wires is made of metal.

8. The touchpad of claim 1, wherein each of the wires is made of ITO.
